(19) United States
(12) Patent Application Publication
(10) Pub. No.: US 2026/0324619 A1
(43) Pub. Date: Oct. 22, 2026

(54) MOUSE TRAP HOUSING BAG IMPROVING SANITATION AND CREATING NO-TOUCH DISPOSAL

(71) Applicant: Lori Garcia, Evergreen, CO (US)

(72) Inventor: Lori Garcia, Evergreen, CO (US)

(21) Appl. No.: 19/651,651

(22) Filed: Apr. 18, 2026

Related U.S. Application Data
(60) Provisional application No. 63/791,592, filed on Apr. 20, 2025.

(51) Int. Cl. A01M 23/24; A01M 23/00

(52) U.S. Cl. CPC A01M 23/245; A01M 23/005

(57) ABSTRACT

A mouse trap system comprises a container housing an attached mouse trap for providing a no touch housing for disposal, comprising an open-top container with an open end and a sealed end, having a flap attached to the sealed end and two sides with a top surface comprised of a first and second peelable sticky surface configured to be peeled for the exposed sticky surface to engage the flap when folded into a closed position creating a closed top surface. A third peelable sticky surface on an inner bottom surface of the container configured to receive a rodent trap to secure it to the inner bottom surface. The container configured with an open end and a closed end with a rodent able to enter the open end to access the rodent the rodent trap and house the activated trap for disposal.

### CROSS REFERENCE TO RELATED APPLICATIONS

This application claims priority from provisional patent application 63/791,592, filed on Apr. 20, 2025, which is incorporated by reference herein.

### FIELD OF INVENTION

The present invention relates to the field of rodent control traps, and, more particularly to a bag housing a mouse trap providing no-touch disposal.

### BACKGROUND

Mouse traps have been around for years. Traditional wooden snap trap offer a cheap, effective means to deal with a mice infestation, and larger versions can be used to deal with rats. Despite various types of purported improved bring available in the current marketplace, the old-fashioned wooden snap trap remain a very popular, cost effective option to eliminate rodents.

Despite the popularity and cost-effectiveness of the traditional wooden snap trap, many people resist using them. For one, they are squeamish over the idea of actually touching a sprung trap with the dead mouse stuck therein. Many others are concerned at the possible spread of pathogens emanating from the dead carcass. The current invention offers a touch free method of disposing of the trap and improves sanitation in the immediate area of a sprung trap.

### SUMMARY

The invention is a paper bag or box (herein these terms can be used interchangeably and have identical meaning herein) that holds any style of mousetrap inside. The top of the bag forms a flap and opens back toward a sealed in. The bag includes three tape strips. One to hold the trap and the others to attach the flap and seal the bag. It can be used with or without a trap, with the strip on the interior of the bag both large and strong enough to entrap a mouse. A user can use bait of their choice or not even use a trap but rely on the adhesive strip. There can be many designs to choose from for the bag.

In an embodiment, a mouse trap system comprises a container housing an attached mouse trap for providing a no touch housing for disposal, comprising an open-top container with an open end and a sealed end, having a flap attached to the sealed end and two sides with a top surface comprised of a first and second peelable sticky surface configured to be peeled for the exposed sticky surface to engage the flap when folded into a closed position creating a closed top surface. A third peelable sticky surface on an inner bottom surface of the container configured to receive a rodent trap to secure it to the inner bottom surface. The container configured with an open end and a closed end with a rodent able to enter the open end to access the rodent the rodent trap and house the activated trap for disposal.

In an embodiment, a mouse trap containment device comprises a container, comprising an open-top container with an open end and a sealed end, having a flap attached to the sealed end and a top surface at the sides with a first and second adhesive surface configured to engage the flap when folded into a closed position creating a closed top surface. A third adhesive surface on an inner bottom surface of the container configured to receive a rodent trap to secure it to the inner bottom surface. The container configured with an open end and a closed end that holds the rodent trap and rodent carcass for disposal.

In an embodiment, a method for using a mouse trap containment device, comprising the steps of providing a box having an open flap to access an inner surface to attach a mouse trap, using an adhesive strip on the bottom of box to attached the mouse trap to secure the mouse trap in place. Attaching a baited mouse trap to the adhesive strip at the bottom of the box. Folding the flap closed and pressing the adhesive strip to close the flap. Picking up the box, closing the open end and disposing.

In an embodiment, a mouse trap system comprises a container housing an attached mouse trap for providing a no touch housing for disposal. An open-top container with an open end and a sealed end, having a flap attached to the sealed end and two sides with a folded over top surface comprised of a first and second peelable sticky surface configured to be peeled for the exposed sticky surface to engage the flap when folded into a closed position creating a closed top surface. A third peelable sticky surface on an inner bottom surface of the container configured to receive a rodent trap to secure it to the inner bottom surface. The container configured with an open end and a closed end with a rodent able to enter the open end to access the rodent trap and house the activated trap for disposal.

In an embodiment, A mouse trap containment device comprising a container, comprises an open-top container with an open end and a sealed end, having a flap attached to the sealed end and a top surface at the sides with a first and second adhesive surface configured to engage the flap when folded into a closed position creating a closed top surface. A third adhesive surface on an inner bottom surface of the container. The container configured with an open end and a closed end that holds a rodent carcass for disposal.

In an embodiment, a method for using a mouse trap containment device, comprising the steps of providing a box having an open flap to access an inner surface to attach a mouse trap. Including a top adhesive flat surface at the top of two sides of the box in an open configuration able to mate to a surface of the open flap to create a closed configuration. Using an adhesive strip on the bottom of the box to attached the mouse trap and secure the mouse trap in place. Attaching a baited mouse trap to the adhesive strip at the bottom of the box. Folding the flap closed and pressing the adhesive strip to close the flap. picking up the box, closing the open end, and disposing.

Advantages:
1. Improved sanitation as the bag isolates a sprung trap from the surrounding vicinity.
2. An aesthetical method for using a snap trap.
3. A no-touch method for disposing of a trapped mouse providing a mess-free way to trap and dispose of a mouse or other rodent.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an exemplary top view of a mouse trap bag featuring a solid neutral design, according to an embodiment of the present invention;

FIG. 2 is an exemplary top view of a mouse trap bag featuring a cartoon design, according to an embodiment of the present invention;

FIG. 3 is an exemplary top view of a mouse trap bag featuring a decorative multi-color design, according to an embodiment of the present invention;

FIG. 4 is an exemplary top view of a lightly constructed box featuring sticky adhesive surfaces, according to an embodiment of the present invention; and

FIG. 5 is an exemplary top view of the box of FIG. 4, according to an embodiment of the present invention.

### DETAILED DESCRIPTION OF PREFERRED EMBODIMENTS

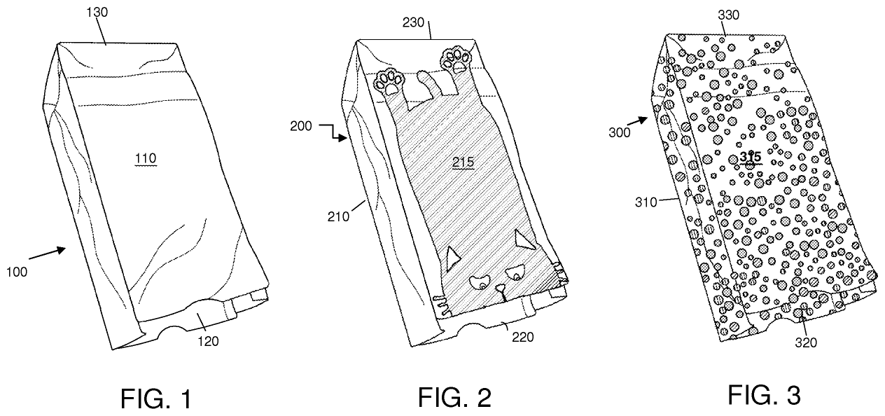

Preferred embodiments of the present invention and their advantages may be understood by referring to FIGS. 1-5, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIGS. 1-3 shows an embodiment of an exemplary bag or lightweight box that is used to secure a mouse trap, such as a wooden snap trap but other types of traps as well. The bag/box can feature a solid neutral colored surface, a whimsical cartoon figure printed on the surface, or a multi-color design printed on the surface.

In use, this bag/box can be placed in an area with a mice infestation with an armed and baited trap attached to the adhesive strip for a mouse to enter the box and activate the trap killing the mouse. Alternatively, the strip can be large and strong enough to entrap a mice coming in contact with the strip and then disposed. In another alternate embodiment, bait can be placed in the back of the bag to attract a rodent inside. The user can then collapse the front opening closed and dispose of the trapped rodent outside.

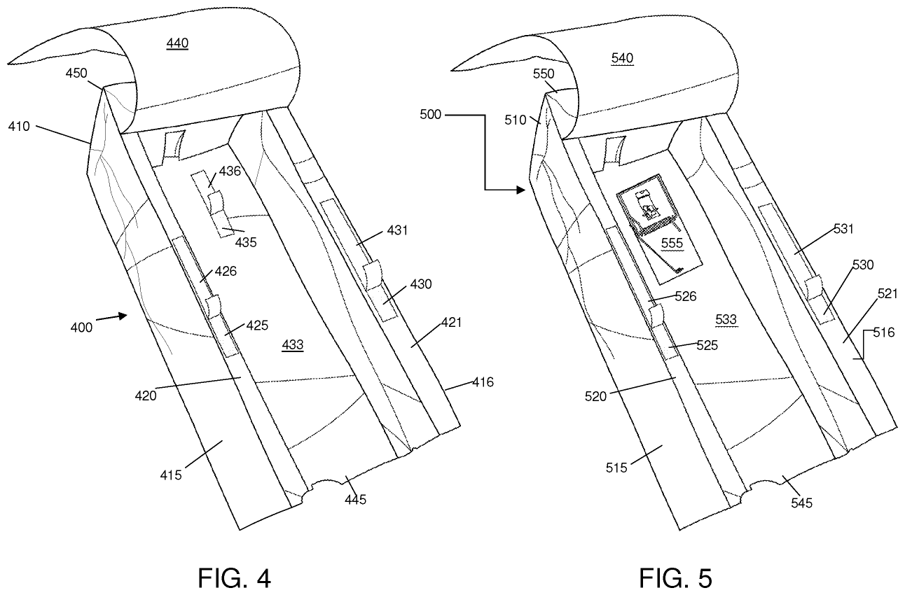

As depicted in FIG. 1, paper bag 100 includes a conventional paper bag body 110 with side folds. The paper bag body 110 includes an open end 120 and an opposed closed end 130. FIG. 2 depicts a paper bag 200 includes a conventional paper bag body 210 with side folds. The paper bag body 210 that includes a decorative print 215 showing a stylized cat on the top. It also depicts an open end 220 and an opposed closed end 230. FIG. 3 depicts a paper bag 300 that includes a conventional paper bag body 310 with side folds. The paper bag body 310 includes a decorative print 215 all over the bag body 310. It also depicts an open end 320 and an opposed closed end 330. The open ends 120, 220, and 320 can be closed. These bags 100, 200, and 300 are intended to receive the box/bags of FIGS. 4 and 5 for disposal.

The bag/box comprises an open top extending at least a majority of the length of the box with a top flap attached at the sealed bottom configured to fold over to fit flush onto the top of sides of the bag/box. The top of the bag/box sides can be folded over to form an elongated flat strip with a sticky surface to mate with the flap when folded over and in place. The bag/box sides further comprise a sticky adhesive surface covered by a peelable strip protecting the sticky surface. A third sticky surface covered by a peelable strip protecting the sticky surface is found proximate to the sealed end opposite from an open end of the bag/box on a base surface of the bag/box. The third sticky surface unpeeled and exposed can accommodate a traditional snap trap attached to the sticky surface securing the trap in place. The sides are likewise unpeeled so the flap can be folded over and secured by those sticky surfaces. The assembled bag/box with an armed snap trap can be emplaced to await a mouse's entry into the box to trip the trap. This bag/box can be constructed from light cardboard or paper. Alternatively, the third sticky surface can be large enough and strong enough to entrap a mouse coming into contact with the sticky surface.

FIG. 4 depicts an exemplary light weight bag/box 400. The bag/box 400 can comprise a bag/box body 410 having a left side 415 and a right side 416. The sides 415 and 416 can include a left elongated flat strip 420 and a right side elongated flat strip 421. As shown, an adhesive strip 425 can be positioned at the mid-point of the right side elongated flat strip 420 and can extend along the elongated flat strip 420 for several inches. A removable protective strip 426 can cover the adhesive strip 425 and can be removed to expose adhesive strip 425. Also as shown, an adhesive strip 430 can be positioned at the mid-point of the left side elongated flat strip 421 and can extend along the elongated flat strip 421 for several inches. A removable protective strip 431 can cover the adhesive strip 430 and can be removed to expose adhesive strip 430.

The bag/box body 410 can also include an inner bottom surface 433. As depicted, the bottom surface 433 can include an adhesive strip 435 attached to the bottom surface 433 and can include a protective strip 436 covering the adhesive strip 435. The bag/box body 410 can include a flap 440 to fold over and fit against the adhesive strips 425 and 430 to create a closed top of bag/box body 410. This forms peelable sticky surfaces 426 and 431 configured to be peeled for the exposed sticky surfaces 425 and 430 to engage the flap 440 when folded into a closed position creating a closed top surface. A rodent can then enter the bag/box body 410 through open end 445. The bag/box body 410 can also include sealed end 450. This bag/box 410 can be constructed from light cardboard or paper.

FIG. 5 shows the third sticky surface unpeeled and exposed with a traditional snap trap attached to the sticky surface securing the trap in place. FIG. 5 depicts an exemplary light weight bag/box 500. The bag/box 500 can comprise a bag/box body 510 having a left side 515 and a right side 516. The sides 515 and 516 can include a left elongated flat strip 520 and a right side elongated flat strip 521. As shown, an adhesive strip 525 can be positioned at the mid-point of the right side elongated flat strip 520 and can extend along the elongated flat strip 520 for several inches. A removable protective strip 526 can cover the adhesive strip 525 and can be removed to expose adhesive strip 525. Also as shown, an adhesive strip 530 can be positioned at the mid-point of the left side elongated flat strip 521 and can extend along the elongated flat strip 521 for several inches. A removable protective strip 531 can cover the adhesive strip 530 and can be removed to expose adhesive strip 530.

The bag/box body 510 can also include an inner bottom surface 533. As depicted, the bottom surface 533 can include an snap trap 555 attached to the bottom surface 533 using adhesive strip 430. The bag/box body 510 can include a flap 540 to fold over and fit against the adhesive strips 525 and 530 to create a closed top of bag/box body 510. This forms peelable sticky surfaces 526 and 531 configured to be peeled for the exposed sticky surfaces 525 and 530 to engage the flap 540 when folded into a closed position creating a closed top surface. A mice or rat can then enter the bag/box body 510 through open end 545. The bag/box body 510 can also include sealed end 550. Alternatively, bottom 533 can comprise a sticky surface that can be large enough and strong enough to entrap a mouse coming into contact with the sticky surface.

This bag/box 510 can be constructed from light cardboard or paper.

The invention can be utilized as follows:
1. Open flap on bag to access surface to attach trap
2. Put adhesive strip on bottom of trap to keep trap in place
3. Set and bait trap
4. Put trap toward bottom of bag
5. Peel and press the tape to close flap
6. Trap mouse
7. Pick up bag, close top and dispose

Insofar as the description above and the accompanying drawing disclose any additional subject matter that is not within the scope of the single claim below, the inventions are not dedicated to the public and the right to the one or more applications to claim such additional inventions is reserved.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The foregoing has described methods and systems for a saw platform apparatus for making faster and more precise crosscuts in the construction trade that are given for illustration and not for limitation and uses. Thus, the inventions are limited only by the appended claims. Although the inventions have been described in accordance with the embodiments shown, one of ordinary skill in the art will readily recognize that there could be variations to the embodiments and those variations would be within the spirit and scope of the present inventions. Accordingly, many modifications may be made by one of ordinary skill in the art without departing from the spirit and scope of the appended claims.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, are incorporated herein by reference. Aspects of embodiments can be modified, if necessary, to employ the systems, functions, and concepts of the various references to provide yet further embodiments.

In light of the above “Detailed Description,” the Inventors may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventors. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventors contemplate the various aspects in any number of claim forms. Accordingly, the inventors reserve the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the disclosure.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

The invention can be configured as two nested bags or an outer bag and an inner box with the inner bag housing the activated trap and dead mouse carcass.

The adhesive strip securing the rodent trap in the inner box/bag can be attached to either the inner box/bag or the rodent trap. The adhesive strip can either be double sided or glued in place on one side to either the box/bag of the rodent trap.

There can be many designs to choose from for the bag.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

I claim:

1. A rodent trap system comprising a container housing an attached rodent trap for providing a no touch housing for disposal, comprising:
an open-top container with an open end and a sealed end, having a flap attached to the sealed end and two sides with a folded over top surface comprised of a first and second peelable sticky surface configured to be peeled for the exposed sticky surface to engage the flap when folded into a closed position creating a closed top surface;
a third peelable sticky surface on an inner bottom surface of the container configured to receive a rodent trap to secure it to the inner bottom surface;
the container configured with an open end and a closed end with a rodent able to enter the open end to access the rodent trap and house the activated trap for disposal.

2. The rodent trap system of claim 1, further comprising:
an associated paper bag that includes an open end and an opposed closed end intended to receive the container and close the open end to dispose the enclosed container.

3. The rodent trap system of claim 2, wherein the associated paper bag includes a decorative outer print.

4. The rodent trap system of claim 1, wherein the container comprises light cardboard.

5. The rodent trap system of claim 1, wherein the container comprises heavy weight paper.

6. The rodent trap system of claim 1, wherein the rodent trap comprises a wooden snap trap.

7. A rodent trap containment device comprising a container, comprising:
an open-top container with an open end and a sealed end, having a flap attached to the sealed end and a top surface at the sides with a first and second adhesive surface configured to engage the flap when folded into a closed position creating a closed top surface;
a third adhesive surface on an inner bottom surface of the container;
the container configured with an open end and a closed end that holds a rodent carcass for disposal.

8. The rodent trap of claim 7, wherein the inner bottom surface of the container is configured to receive a rodent trap on the third adhesive surface to secure the rodent trap to the inner bottom surface.

9. The rodent trap of claim 7, wherein the inner bottom surface of the container comprises an adhesive surface for entrapping a rodent.

10. The rodent trap of claim 7, further comprising:
an associated paper bag that includes an open end and an opposed closed end intended to receive the container and close the open end to dispose the enclosed container.

11. The rodent trap of claim 7, wherein the associated paper bag includes a decorative outer print.

12. The rodent trap of claim 7, wherein the container comprises light cardboard.

13. The rodent trap of claim 7, wherein the container comprises heavy weight paper.

14. The rodent trap of claim 7, wherein the rodent trap comprises a wooden snap trap.

15. A method for using a mouse trap containment device, comprising the steps of:
providing a box having an open flap to access an inner surface to attach a mouse trap;
including a top adhesive flat surface at the top of two sides of the box in an open configuration able to mate to a surface of the open flap to create a closed configuration;
using an adhesive strip on the bottom of the box to attached the mouse trap and secure the mouse trap in place;
attaching a baited mouse trap to the adhesive strip at the bottom of the box;
folding the flap closed and pressing the adhesive strip to close the flap; and
picking up the box, closing the open end, and disposing.

16. The method for using a mouse trap containment device of claim 15, further comprising:
providing an associated paper bag that includes an open end and an opposed closed end intended to receive the container and close the open end to dispose the enclosed container.

17. The method for using a mouse trap containment device of claim 15, wherein the associated paper bag comprises a decorative outer print.

18. The method for using a mouse trap containment device of claim 15, wherein the container comprises light cardboard.

19. The method for using a mouse trap containment device of claim 15, wherein the container comprises heavy weight paper.

20. The method for using a mouse trap containment device of claim 15, wherein the mouse trap comprises a wooden snap trap.
